(19) United States
(12) Patent Application Publication
(10) Pub. No.: US 2022/0250873 A1
(43) Pub. Date: Aug. 11, 2022

(54) ELECTROMECHANICAL ACTIVATION OF A BIDIRECTIONAL EMERGENCY STOP DEVICE FOR A LIFT

(71) Applicant: DYNATECH, DYNAMICS & TECHNOLOGY, S.L., Pina de Ebro, Zaragoza (ES)

(72) Inventor: Francisco de Asis MATEO MUR, Pina de Ebro, Zaragoza (ES)

(21) Appl. No.: 17/629,973

(22) PCT Filed: Aug. 29, 2019
(86) PCT No.: PCT/ES2019/070576

§ 371 Date: Jan. 25, 2022

(51) Int. Cl. B66B 5/18

(52) U.S. Cl. CPC B66B 5/18

(57) ABSTRACT

The electromechanical bidirectional emergency stop device for a lift comprises a support plate (22) equipped with retention means, intermediate means for transmitting the displacement towards two articulated levers (5) which, at their free ends, have a grooved roller (7) attached by means of a roller cam (20), where each articulated lever (5) rotates with respect to one of their ends and the intermediate means of transmission comprise a linearly moveable carriage (3) connected with the mobile end of the retention means, where in turn the moveable carriage is connected in an articulated manner with an articulated carriage (4) responsible for the transmission of the displacement to the articulated levers (5) through transmission connecting rods (6) that are connected in an articulated manner at their midpoint with the articulated levers (5), with a compensation spring (9) for the weight of the device and an articulated lever recovery spring.

### TECHNICAL FIELD OF THE INVENTION

The object of this invention, as stated in the title of the invention, is an electromechanical bidirectional emergency stop device for a lift that acts as an interface between an electronic overspeed detection system and the device that stops the lift cabin in case of an emergency.

This invention is characterised by the special configuration and design of each of the parts of the mechanism to achieve an effective a safe transmission between an electronic device for overspeed detection and an element that stops the cabin, allowing the same device to be activated both while ascending and descending.

This invention lies therefore within the field of lifts, and, in particular, safety measures used to stop a lift.

### BACKGROUND OF THE INVENTION

Due to the evolution of the market towards more precise and versatile electronic components, components which have traditionally been mechanical within lifts are being replaced by electronic components. Communication between the new electronic components and existing mechanical components requires novel developments in the market that link both types of components.

The force of mechanical activation by means of a cable and the adhesion of this cable in a throat of the pulley is replaced by the activation of a spring retained by a coil.

The system's new electronic elements for overspeed detection open a contact at the moment they encounter this safety failure. Thus, these solutions are based on an electromechanical element for activating the parachutes.

As soon as there is a power cut in the system, the coil is de-energised and a spring applies the activation force for the parachute, bringing the roller to its braking position.

There are several solutions that are known in the state of the art, such as those described in the patents:

WO2014075954, which is not a bidirectional system and lacks a means of compensation for potential imbalances.

EP1749784, which is also not a bidirectional system and does not take into account potential imbalances.

CH707833 is based on the use of brake shoes that produce a friction action on a guide rail. Although it uses articulated levers, it is not a bidirectional system.

Therefore, it is the object of this invention to develop bidirectional solutions for the braking of lifts in emergency situations that can serve as an interface between the braking means and the means for electronic detection.

### DESCRIPTION OF THE INVENTION

The object of this invention is an electromechanic bidirectional emergency lift stop device, comprising a support plate on which retention means are mounted, which then act on transmission means towards articulated levers equipped, at their ends, with a set of connecting rods and grooved rollers that run through channels made on a cover.

The retention means, in a first embodiment, comprise a coil and a retention spring so that, once the spring is released, the intermediate means of transmission of the displacement are displaced and these, in turn, move the articulated levers enabling them to rotate and causing one of the rollers to become wedged, while the other roller becomes hidden to avoid rubbing against the guide.

The intermediate means of transmission of the displacement comprise a first carriage, to which a second articulated carriage is attached that, in addition to being able to move linearly, can also swing, and thus has three articulated joints: a first joint articulated with the first carriage, and the two other joints articulated with two corresponding connecting rods that are joined with the articulated levers at a midpoint between them.

In order to compensate for the effect of the weight of the upper groove roller assembly, the device has a compensation spring that prevents the action of gravity, preventing the upper roller of the braking device from coming unhooked.

Also, and in order to allow the rearming of the articulated levers, once the emergency braking operation is completed on each of the articulated levers, the rollers have a recovery spring mounted on an arm attached to the articulated levers at an intermediate point along their length, such that it allows the recovery of the grooved roller.

Except when stated otherwise, all the technical and scientific elements used in this specification have the meaning usually understood by a person skilled in the art of this invention. In practice, this invention can use processes and materials that are similar or equivalent to those described in the specification.

Throughout the description and claims the term comprises and the various forms thereof are not meant to exclude other techniques, additives, components or steps. A person skilled in the art will recognise that other objects, advantages and features of the invention follow in part from the description and in part from the practising of the invention.

### BRIEF DESCRIPTION OF THE DRAWINGS

In order to complement the description being made and to aid towards a better comprehension of the features of the invention, according to our preferred practical embodiment, we incorporate as an integral part of said description a set of drawings that are illustrative and not limiting in nature and represent the following.

In FIG. 1, we can see a front view of the device that is the object of the invention in a retained position and ready for activation.

FIG. 2 shows the electronic diagram of the power source that is the object of the invention.

FIG. 3 shows the activated device starting its displacement to achieve the wedging of the guide.

FIG. 4 shows a detailed diagram of the recovery spring of the articulated levers.

FIGS. 5 and 6 show the means used to monitor the position of the coil.

FIGS. 7, 8 and 9 show an alternative to the retention means based on the use of a suction coil.

### DETAILED DESCRIPTION OF THE INVENTION

In view of the figures, a preferred embodiment of the proposed invention is described below.

The bidirectional device, as seen in FIG. 1, comprises a support plate (22) on which retention means are mounted such that, once deactivated, they cause the displacement of intermediate means of transmission of the displacement which, in turn, produces the articulation of two articulated levers (5) that at their free ends (5) each have a grooved roller (7) attached by means of a roller cam (20).

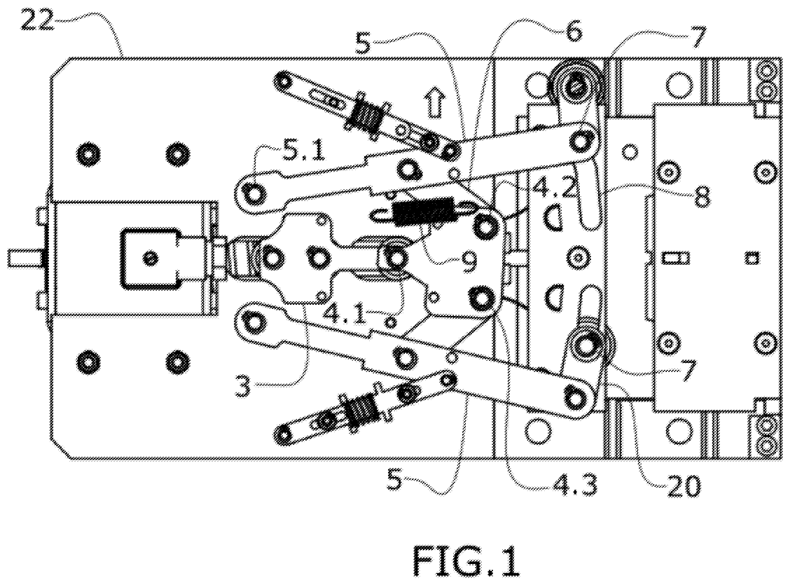

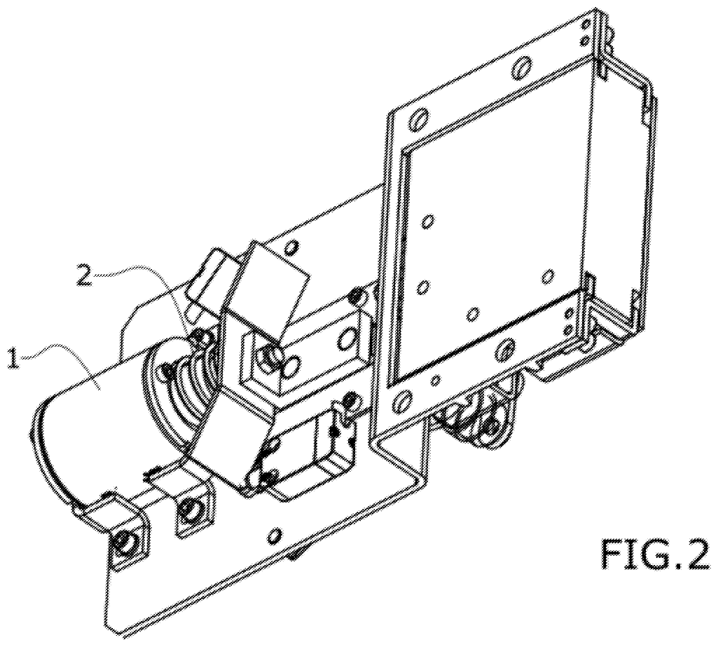

In FIG. 2 we can see the retention means used in a first embodiment, which consists of a coil (1) that, when activated, has a compressed activation spring (2), such that when the coil is deactivated the activation spring (2) moves, becoming decompressed.

The intermediate transmission means comprise a linearly movable carriage (3) connected with the mobile end of the activation spring (2), where, in turn, the movable carriage is connected in an articulated manner to an articulated carriage (4), which is responsible for transmission of the displacement to the articulated levers (5) by means of transmission connecting rods (6), which are joined in an articulated manner at a middle point with the articulated levers (5).

Each articulated lever (5) rotates with respect to one of its ends by means of an articulated joint (5.1), whereas the roller cam (20) is attached to it at the opposite end, which is in turn attached to the grooved roller (7), which runs through a curved channel (8) made on a cover.

The articulated carriage (4) is equipped with three articulated joints (4.1), (4.2) and (4.3). The first articulated joint (4.1) connects the end of the linearly moveable carriage (3), while each of the two other articulated joints, the second articulated joint (4.2) and the third articulated joint (4.3), are connected to each of the transmission connecting rods (6).

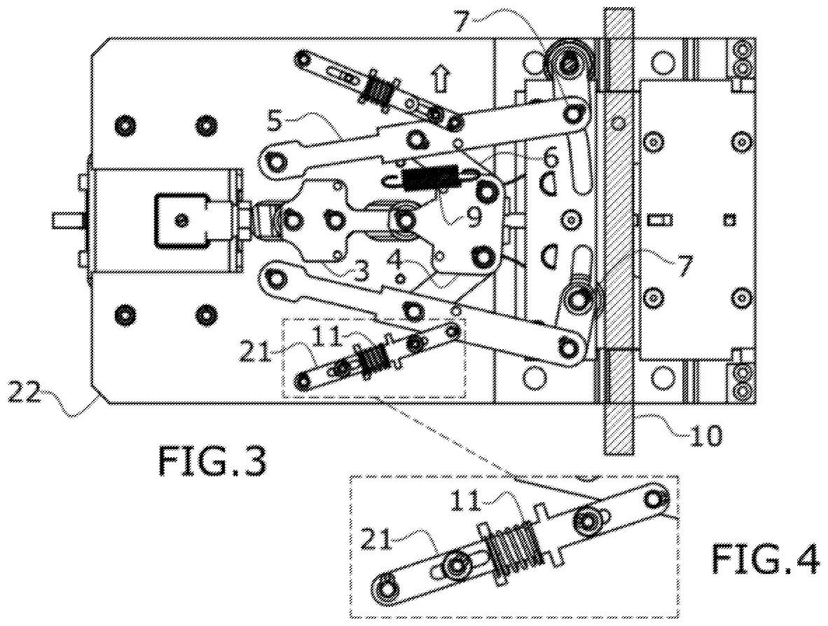

FIG. 3 shows that when the retention means are no longer activated, and therefore the emergency stop of the lift is activated, the articulated carriage (4) has not only experienced a translation but also a tilt, which will depend on the upward or downward movement of the guide (10), with the wedging of one roller (7) and not the other depending on the braking direction. One of the grooved rollers (7) continues its movement through the curved channel (8) to its wedging position, while the other becomes hidden to avoid rubbing with the guide (10).

Both FIG. 1 and FIG. 3 show the presence of a compensation spring (9) that is associated with the articulated carriage (4) and whose mission is to compensate for the effect of the weight of the upper groove roller assembly due to gravity since the device works vertically, as can be observed. In the embodiment shown, the compensation spring is arranged so that one end is connected to the linearly moveable carriage (3) and the other end to the articulated carriage (4).

FIG. 4 aims to emphasize the use of recovery springs (11) mounted on arms (21), which act only at the end of the movement along the guide (10), and serve to help the grooved rollers (7) to reach their lift operating position, that is, it favours the return of the articulated levers to their retention position.

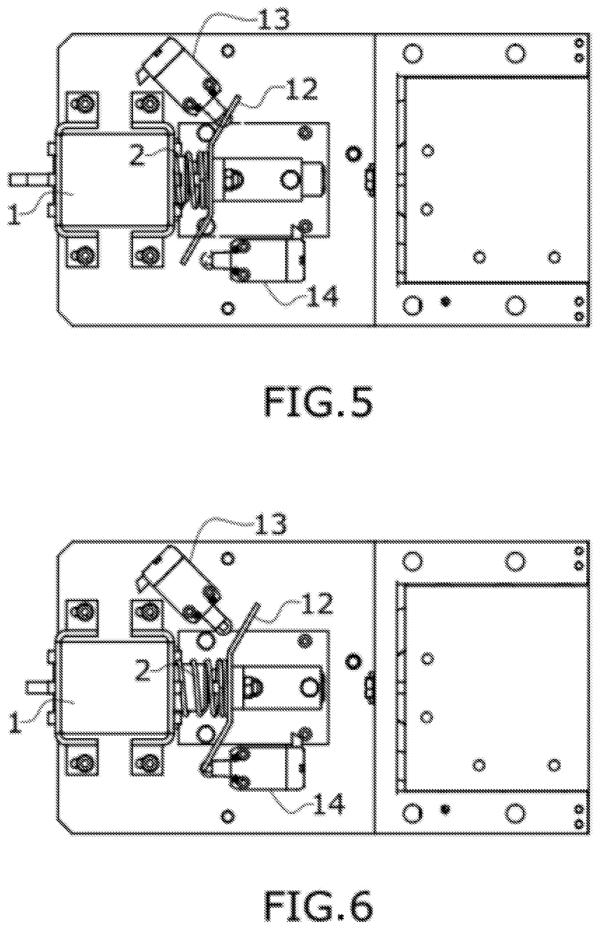

The detection of the position of the coil (1) is monitored by means of a first contact (13) and a second contact (14) in combination with a moveable plate (12) attached to the free end of the retention spring (2), or whichever retention means used, so that depending on the position of the spring (2) the first contact (13) or the second contact (14) will be activated, as shown in FIGS. 5 and 6.

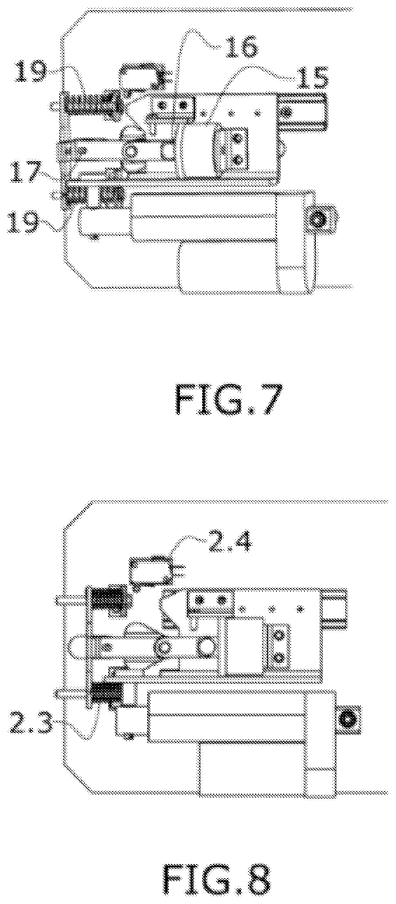

Finally, the retention means, in an alternative embodiment, can be as shown in FIGS. 7, 8 and 9, where they can be seen to comprise a suction coil (15), to which a moveable part (16) is coupled or uncoupled, moved either by magnetically acting upon the suction coil (15) or by the force of springs (19).

The moveable part (16) is attached to an articulated assembly (17) which, in turn, is connected at the end opposite to the joint with the moveable part (17) to an end plate (18), where connection of the joint assembly (17) on the end plate (18) is at its midpoint, both ends being joined together with the springs (19).

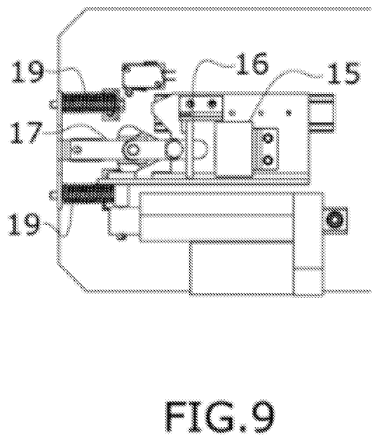

FIG. 8 shows when the moveable part (16) is attracted by the suction coil (15), causing the joint assembly (17) to drag the end plate (18) and the latter presses down on the springs (19), whereas FIG. 9 shows how the suction coil (15) ceases to be activated by the force of the springs (19), causing the dragging of the end piece (18), which in turn causes the dragging of the moveable part (16) by means of the joint assembly (17).

Having sufficiently described the nature of this invention and the embodiment thereof, it is noted that without departing from the essence thereof, other embodiments are possible that may differ in certain details from that given by way of example, which will also be included in the scope of protection sought, provided the main principle of the invention is not altered, changed or modified.

1. Electromechanical bidirectional emergency stop device for a lift comprising a support plate (22) on which retention means are mounted such that, once deactivated, they cause the displacement of intermediate means of transmission of the displacement and which, in turn, produces the articulation of two articulated levers (5) that at their free ends (5) each have a grooved roller (7) attached by means of a roller cam (20), characterised in that:
Each articulated lever (5) rotates with respect to one of its ends by means of an articulated joint (5.1), whereas the roller cam (20) is attached to it at the opposite end, which is in turn attached to the grooved roller (7), which runs through a curved channel (8).
The intermediate transmission means comprise a linearly movable carriage (3) connected with the mobile end of the retention means, where, in turn, the movable carriage is connected in an articulated manner to an articulated carriage (4), which is responsible for transmission of the displacement to the articulated levers (5) by means of transmission connecting rods (6), which are joined in an articulated manner at a middle point with the articulated levers (5).

2. Electromechanical bidirectional emergency stop device for a lift according to claim 1 characterised in that the articulated carriage (4) is equipped with three articulated joints (4.1), (4.2) and (4.3); the first articulated joint (4.1) connects the end of the linearly moveable carriage (3), while each of the two other articulated joints, the second articulated joint (4.2) and the third articulated joint (4.3), are connected to each of the transmission connecting rods (6).

3. Electromechanical bidirectional emergency stop device for a lift according to claim 1 or 2, characterised in that it comprises a compensation spring (9) that is associated with the articulated carriage (4) and whose mission is to compensate for the effect of the weight of the upper grooved roller assembly due to gravity.

4. Electromechanical bidirectional emergency stop device for a lift according to claim 3 characterised in that the compensation spring is arranged so that one end is connected to the linearly moveable carriage (3) and the other end to the articulated carriage (4).

5. Electromechanical bidirectional emergency stop device for a lift according to any of the preceding claims, characterised in that each of the articulated levers has an articulated arm (21) on which a recovery spring (11) is placed, and they serve to recover the initial position of each articulated lever.

6. Electromechanical bidirectional emergency stop device for a lift according to any of the preceding claims characterised in that the retention means used consist of a coil (1) which, once activated, has a compressed activation spring (2) so that, when the coil is deactivated, the activation spring (2) moves, decompressing.

7. Electromechanical bidirectional emergency stop device for a lift according to any of the preceding claims characterised in that the retention means used consist of a suction coil (15) to which a moveable part (16) is coupled or uncoupled, which part is moved either by the magnetic action of the suction coil (15) or by the force of springs (19), where the moveable part (16) is connected to an articulated assembly (17) which, in turn, is connected at the end opposite to the joint with the moveable part (17) to an end plate (18), where the joint assembly (17) is joined to the end plate (18) at its midpoint, with both ends being connected to the springs (19).

8. Electromechanical bidirectional emergency stop device for a lift according to any of the preceding claims characterised in that the detection of the position of the coil (1) is monitored by means of a first contact (13) and a second contact (14) in combination with a moveable plate (12) attached at the free end of the retention means such that, depending on its position, the first contact (13) or the second contact (14) will be activated.
